(19) United States
(12) Patent Application Publication
(10) Pub. No.: US 2026/0086374 A1
(43) Pub. Date: Mar. 26, 2026

(54) WEARABLE ELECTRONIC DEVICE

(71) Applicant: Apple Inc., Cupertino, CA (US)

(72) Inventors: Alison B. Shutzberg, San Francisco, CA (US); Brynna E. Freitag, San Francisco, CA (US); Ibuki Kamei, Santa Clara, CA (US)

(21) Appl. No.: 19/077,516

(22) Filed: Mar. 12, 2025

Related U.S. Application Data
(60) Provisional application No. 63/697,375, filed on Sep. 20, 2024.

(51) Int. Cl. G02B 27/01; G02C 5/14; G02C 11/00

(52) U.S. Cl. CPC G02B 27/0176; G02C 5/14; G02C 11/10

(57) ABSTRACT

A wearable display device includes a frame, and a display window coupled to the frame. The wearable display device includes a securement arm having a proximal portion including a shell pivotally coupled to the display frame at a proximal end of the shell, the shell having a distal end opposite the proximal end and defining a port between the distal end and the proximal end. The securement arm further includes a distal portion coupled to the distal end, the distal portion defining a first internal volume having an adjustable curvature. The wearable display device can include a flexible conduit disposed in the first internal volume, the flexible conduit defining a second internal volume, and a speaker disposed in the first internal volume, the second internal volume configured to direct sound from the speaker to the port.

### CROSS-REFERENCE TO RELATED APPLICATIONS

This claims priority to U.S. Provisional Patent Application No. 63/697,375 , filed 20 Sep. 2024, and entitled “WEARABLE ELECTRONIC DEVICE,” the entire disclosure of which is hereby incorporated by reference.

### FIELD

The present disclosure relates generally to wearable electronic devices. More particularly, the present disclosure relates speaker systems and assemblies for a wearable electronic device.

### BACKGROUND

Various components of head-mountable devices (HMD), such as display screens, viewing frames, securement arms, speakers, batteries, waveguides, and other components, can operate together to provide immersive alternate and virtual reality experiences. These components can demand power for operation from power sources such as batteries. These components take up space within the HMD and do not allow for a large battery to increase the operation of the device. Many components are disposed within arms of the HMD that include curvature as to secure behind a user's ear. However, many components are not flexible and cannot be disposed within the flexible portions of the arm or those that include the curvature.

Therefore, there is a need for an HMD with components that can be flexible to allow an HMD to house a larger battery to increase the operational time.

### SUMMARY

In at least one example of the present disclosure, a wearable display device includes a frame and a display window coupled to the frame. The wearable display device can include a securement arm that includes a proximal portion including a shell pivotally coupled to the display frame at a proximal end of the shell, the shell having a distal end opposite the proximal end and defining a port between the distal end and the proximal end. The securement arm further includes a distal portion coupled to the distal end, the distal portion defining a first internal volume having an adjustable curvature. The wearable display device further includes a flexible conduit disposed in the first internal volume, the flexible conduit defining a second internal volume, and a speaker disposed in the first internal volume, the second internal volume configures to direct sound from the speaker to the port.

In one example, the wearable electronic device further includes a battery disposed within the shell and the flexible conduit includes a slotted tube. In one example, the flexible section can be disposed in the distal portion, and the flexible conduit is disposed between the speaker and the port. In one example, the wearable electronic device further includes a tape, and the tape covers an outer surface of the flexible conduit sealing the second internal volume. In one example, the flexible portion includes an overmolded portion positioned at least partially over the flexible conduit and the tape. In one example, the wearable electronic device further includes a microphone, the microphone disposed within the proximal portion, a transparent window coupled to the display frame, and a projector configured to direct light displayed at the transparent window. In one example, the wearable electronic device further includes an acoustic seal disposed in the proximal portion, the acoustic seal disposed proximal to the port.

In at least one example of the present disclosure, a wearable electronic device includes a display frame and a display window coupled to the display frame. The wearable electronic device includes a securement arm having a proximal portion including a shell pivotally coupled to the frame at a proximal end of the shell, the shell having a distal end opposite the proximal end and defining an aperture, and a distal portion coupled to the distal end, the distal portion defining an internal volume and the distal portion including a flexible portion. The wearable electronic device further includes a speaker disposed in the internal volume and an audio conduit defined by the flexible portion between the speaker and the aperture.

In one example, the audio conduit can direct audio from the speaker to the aperture and the audio conduit defines a second internal volume. In one example, the wearable electronic display further includes a battery disposed within the shell and a flexible conduit disposed in the second internal volume. In one example, the flexible portion includes an overmolded portion positioned at least partially over the audio conduit.

In at least one example of the present disclosure, a securement arm for a wearable electronic device includes a proximal portion configured to be disposed in front of an ear of a user when donned, a distal portion configured to be disposed behind the ear, and a speaker disposed within the distal portion.

In one example, the securement arm further includes a flexible conduit disposed within the distal portion, the flexible conduit defining an internal volume. In one example, the securement arm further includes an overmolded flexible material positioned at least partially over the flexible conduit, a speaker disposed within the distal portion, a port disposed proximally to the flexible material, and an acoustic seal disposed proximally to the port. In one example, the flexible conduit is disposed between the speaker and the port, and the flexible conduit is configured to direct audio from the speaker to the port.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a top view of an example of a wearable electronic device;

FIG. 2 illustrates a top view of an example of a wearable electronic device;

FIG. 3A illustrates a side view of a portion of an example of a securement arm for a wearable electronic device;

FIG. 3B illustrates a cross-sectional view of the bisecting line in FIG. 3 of an example of a securement arm for a wearable electronic device;

FIG. 4A illustrates a cross-sectional view of one example of a flexible conduit 322 taken along a plane parallel to the plane 301 indicated in FIG. 3A; and

FIG. 4B illustrates a cross-sectional view of the flexible conduit 322 taken along a plane perpendicular to the plane 301 indicated in FIG. 3A.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The present disclosure generally relates to electronic devices. More particularly, the present disclosure relates to head-mountable electronic devices and speaker systems and assemblies for the same. Examples of head-mountable devices can include optical devices (e.g., glasses, transparent windows, etc.) or virtual/augmented reality devices that can include an optical component. In these cases, the head-mountable device can be donned on the head of a user such that optically transparent widows, for example, lenses, displays, and transparent optical windows and displays, can be positioned in front of a user's eyes. Other electrical components for the powering and operation of the device can also be disposed in the device, for example data ports and waveguides. Batteries can be disposed in the securement arm and can be electrically coupled to the various other electronic components of the device. Speakers can be disposed distally on the securement arm coupled with the battery. However, many components may not be flexible to be housed within a distal portion of the securement arm that can be configured to have a curve to flex accommodate the unique shape of a user's face and ears.

In many head-mountable devices, operational components can be housed within the securement arms or band of the device, which often extend rearwardly from the display unit. The securement arms or band, for example, can house a speaker and battery. Current devices often house the speaker in the arm or band forward from the ear such that sound can be ported or directed backward or downward toward the ear, which is generally oriented to receive sound from the front. However, having the speaker in the arm or band disposed in front of the ear reduces the space available for other components in front of the ear within the arm or band. IN many cases, portions of the securement arm or band that extends behind the user's ear is curved and/or flexible to conform to the user's head and ear shape and size and increase the securement force on the user's head. The flexibility and adjustment functions of this distal portion of the arm or band limits the types and number of operational components that can be disposed in the distal portion. In addition, in current head-mountable display devices, the on-board batteries are moved forward in the arm or band where more space is available and less circuitry is needed for connecting to the display unit in the front, leaving less room in front of the user's ear when the device is donned for other operational components, such as speakers.

The speaker assemblies and systems described herein are configured for placement in the flexible, adjustable tip of securement arms or bands of head-mountable devices. These speaker assemblies and systems are configured to deliver quality sound to the user and allow for more space for other operational components in the arms or band in front of the user's ear when donned, such as larger batteries, more processing power, and so forth. Accordingly, the securement arms of a head mountable devices described herein are designed for a larger battery housed within a proximal portion of the securement arm and a speaker disposed in a distal portion and configured to curve around a user's ear when donned.

In addition, any electrical components, including a power source and other components mentioned herein, which can be placed in or on the securement arm itself, can be designed and placed strategically to avoid interfering with the weight distribution, securement forces, comfort, and/or field of view of the device and the user. In one example, the speaker disposed in the distal portion of the securement arm that can be behind the user's ear when the device is donned, and the speaker can counterweight weight from the front of the wearable electronic device. This can be advantageous as it can reduce the stress concentration that can occur on a user's nose as the user dons the wearable electronic device for long durations of time.

In order to achieve these and other advantages, in at least one example of the present disclosure, in at least one example of the present disclosure, a wearable electronic device can include a securement arm that can include a proximal portion and a distal portion. The proximal portion can include a shell pivotally coupled to the display frame at a proximal end of the shell, the shell having a distal end opposite the proximal end and defining a port between the distal end and the proximal end. In one example, the port can be defined by the proximal portion such that the port is in front of the user's ear as the user dons the device. The distal portion can be coupled to the distal end and the distal portion defining a first internal volume having an adjustable curvature. The distal portion can be configured to have an adjustable curvature such that the distal portion can be positioned behind the user's ear when the user dons the device. The adjustable curvature of the distal portion can accommodate many users' unique head and ear shapes and sizes.

The wearable electronic device can further include a flexible conduit that can be disposed in the first internal volume defined by the distal portion. In one example, the flexible conduit can define a second internal volume. The device can further include a speaker that can be disposed in the first internal volume. In one example as the speaker is disposed in the first internal volume, the speaker can be disposed distally to the flexible conduit. In this way, as the speaker disposed in the distal portions internal volume, the speaker can be a counterweight such as counterweighting the weight off of the user's nose as the user dons the device. In one example, the second internal volume of the flexible conduit can be configured to direct audio from the speaker to the port defined in front of the user ear. In this way, the speaker can deliver audio in front of the user's ear as the user dons the device to increase the quality of the audio and the privacy of the user's audio.

In at least one example, the flexible conduit can include a slotted tube. In this way, the slotted tube defines the second internal volume that directs the audio from the speaker to the port. The slotted tube can enable the distal portion to have an adjustable curvature and maintain a cross-sectional area and inner diameter that does not collapse as the distal portion curvature is adjusted. In this way the slotted tube can distribute the bending moment to stop a kink from occurring. Therefore, the flexible conduit can maintain the second internal volume during the adjustment of the distal portion such that the audio being directed through the second internal volume does not get interrupted or interfered with to lower the quality of the audio.

In at least one example, the wearable electronic device can include a flexible portion in the distal portion of the securement arm and an audio conduit defined by the flexible portion. The audio conduit can define a second internal volume that can be configured to direct audio from the speaker to the port. In one example, the flexible portion can be an overmolded portion positioned at least partially over the audio conduit. In this way, the flexible portion can articulate the adjustability of the distal portion to accommodate to a user's ears and head. The audio conduit can be advantageous, as the audio conduit is defined by the flexible portion and does not include a flexible conduit and can ease the manufacturing process of the securement arms.

Accordingly, the various examples of head-mountable devices described in the present disclosure can include speakers disposed within flexible, and adjustable distal portions meant to be disposed behind a user's ear during use while still delivering quality sound in front of the user's ears. More space can be provided for other components, for example higher capacity batteries and the like for improved and prolonged device performance.

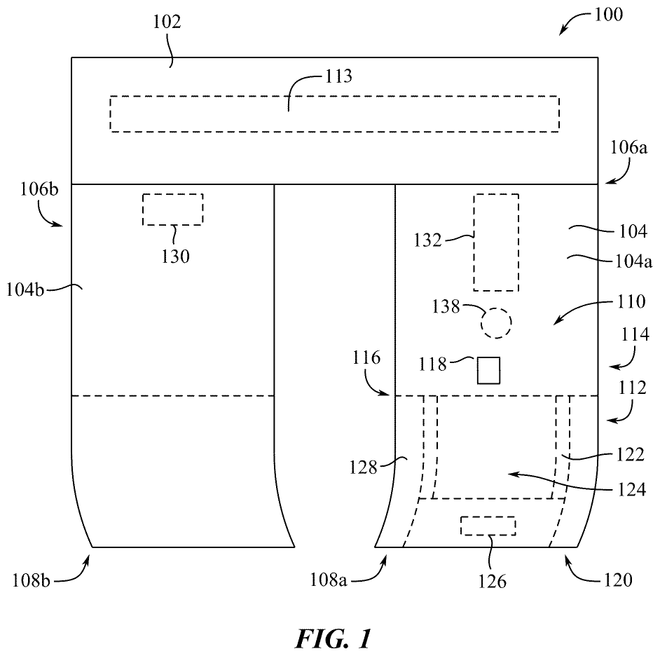

These and other embodiments are discussed below with reference to FIG. 1-3C. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top view of a wearable electronic device 100. The wearable electronic device 100 can be a head-mountable device (HMD) or can be any device or system configured to be worn on the head of a user, such as an optical device, smart glasses, alternate/virtual reality goggles, and the like. As shown in FIG. 1, the device 100 can include at least one display frame 102, which can house a variety of components and systems. In at least one example, the display frame 102 can be configured to secure one or more display windows 113 configured to present visual information to the user. In one or more examples of the present disclosure, the display windows 113 can include optically transparent display windows, display screens, transparent material, optical lenses, or transparent display screens, or combinations thereof, in front of the eyes of the user. The device 100 can include at least one securement arm 104. According to the example shown in FIG. 1, at least one of the securement arms 104a and 104b can be attached to the display frame 102. Securement arms 104a and 104b can include proximal ends 106a and 106b, which can be attached to the display frame 102. Securement arms 104a and 104b can further include distal ends 108a and 108b further extending from the proximal ends 106a and 106b, respectively. In other examples, the securement arms 104a and 104b can be a single securement arm, a flexible band, or the like.

In one example, the distal ends 108a, 108b of the securement arms 104a, 104b can curve inward or downward to comfortably fit behind the user's ears. In this example, the user can adjust the distal end 108a, 108b of the securement arms 104a, 104b curvature to conform the fit around the user's ears. In this way, the wearable electronic device 100 can be donned by users with a variety of user's head such that the device 100 can be donned comfortably during the duration of use.

FIG. 1 illustrates other components, for example various operational components and electrical components, that can be housed within the securement arms 104a, 104b. In one example, securement arms 104a, 104b can include a proximal portion 110 including a shell 114 pivotally coupled to the display frame 102 at the proximal end 106a of the shell 114. The shell 114 can have a distal end 116 opposite the proximal end 106a and the shell 114 can define a port 118. The port 118 can be disposed between the proximal end 106a and the distal end 116. In this way, the port 118 can be defined by the shell 114 such that the port 118 is in front of the user's ear when the user dons the device 100. In at least one example, the port 118 includes an aperture defined by the shell 114, for example a through-hole extending through a thickness of the shell 114 and providing fluid communication between an environment external to the shell 144 and an internal volume of the shell 114 or another portion of the arm 104a. The port 118 in front of the user's ear can deliver audio in front of the ear, where the ear is naturally directed to, to increase the audio quality and the user's audio privacy as the user dons the device.

In one example, the securement arms 104a, 104b can include a distal portion 112 coupled to the distal end 116 of the proximal portion 110. The distal portion 112 can define a first internal volume 120 and the distal portion 112 can have an adjustable curvature. As discussed above the adjustable curvature can be advantageous as to accommodate to many user's ears and heads.

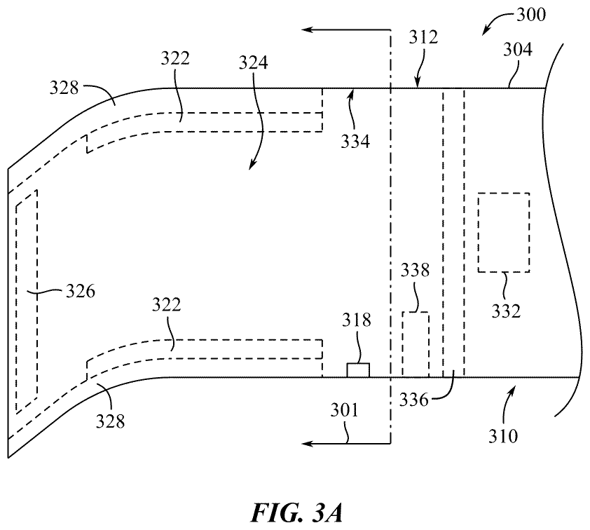

In one example, the device 100 can further include a flexible conduit 122 disposed in the first internal volume 120 defined by the distal portion 112. The flexible conduit 122 can define a second internal volume 124. The device 100 can further include a speaker 126 disposed in the first internal volume 120, the speaker disposed distally to the flexible conduit 122. The flexible conduit 122 disposed between the speaker 126 and the port 118. In one example, the second internal volume 124 can be configured to direct sound or audio from the speaker 126 to the port 118. In at least one example, the flexible conduit 122 can include a slotted tube, as illustrated in FIG. 3C, discussed in more detail below. In this way, the slotted tube defines the second internal volume 124 that directs the audio from the speaker to the port. The slotted tube can enable the distal portion 112 to have an adjustable curvature and maintain a cross-sectional area and inner diameter that does not collapse as the distal portion 112 is adjusted and bent or flexed when donned. In this way the slotted tube can distribute the bending moment to stop a kink from occurring. In this way, the flexible conduit 122 can maintain the second internal volume 124 during the adjustment of the distal portion 112 such that the audio being directed through the second internal volume 124 does not get interrupted and lower the quality of the audio.

In at least one example, the flexible conduit 122 can plastically deform during the adjustment of the distal portion 112. In this example, the slotted section of the flexible conduit 122 can be positioned inward towards the head of the user and the non-slotted portion of the flexible conduit 122 can be positioned facing away from the head. In one example, the flexible conduit 122 can be a tube with a plurality of scores along the length of the tube such that the tube can buckle to adjust the curve of the distal portion 112.

In one example, the wearable electronic device 100 can further include a flexible section 128 disposed in the internal volume 120 of the distal portion 112. The flexible section 128 includes an overmolded portion position at least partially over the flexible conduit 122. In one example, the flexible section 128 can include silicone. The flexible section 128 can be configured to be adjustable such that the flexible section 128 can define the distal portion 112 curvature and hold the curvature as the user dons the device 100. In this way, the distal portion 112 can be curved to comfortably sit behind the user's ears as the user dons the device 100, and the adjustability can accommodate many different user head sizes.

In at least one example, the securement arms 104a and 104b can house a variety of different components, including electrical and/or operational components. As illustrated in FIG. 1, the securement arm 104b can house a waveguide and/or projector 130. The projector 130 can be configured to direct light displayed at the window 118 or a transparent window attached to the display frame 102. The device 100 can further include a battery 132 disposed within the shell 114 of the securement arm 104a. The device 100 can include a microphone 138 disposed within the proximal portion 110, the microphone 138 disposed proximally to the port 118. Although FIG. 1 illustrates the projector 130 in the securement arm 104b, and the battery 132, port 118, flexible section 128, flexible conduit 122, the microphone 138, and the speaker 126 in the securement arm 104a, and it should be understood the components of each securement arm 104a, 104b can in the same securement arm, both securement arms, or any suitable combination within one or more securement arms 104a, 104b not illustrated in FIG. 1.

Any of the features, components, and/or parts, of the rim 360 including the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

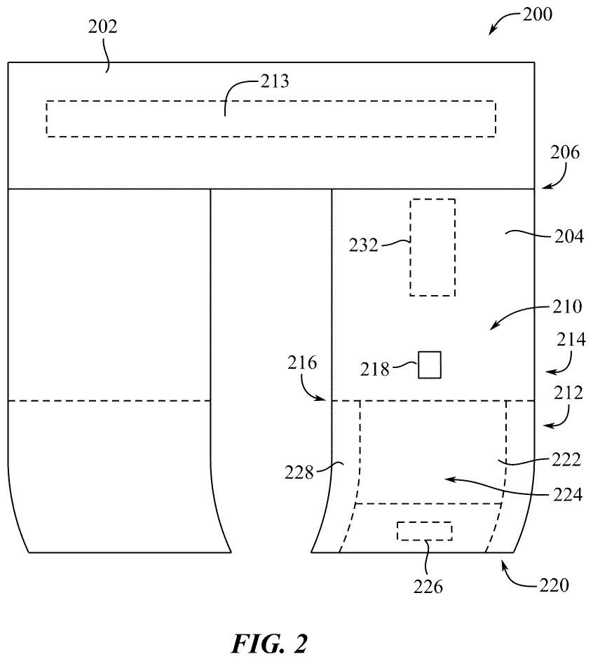

FIG. 2 illustrates a top view of one example of a wearable electronic device 200. As illustrated in FIG. 2, the wearable electronic device 200 can include a display frame 202, a display window 213 coupled to the display frame 202, and a securement arm 204. The securement arm 204 can include a proximal portion 210 including a shell 214 pivotally coupled to the display frame 202 at a proximal end 206 of the shell 214. The shell 214 having a distal end 216 opposite the proximal end 206. The shell 214 can define an aperture 218. The device 200 can include a battery 232 disposed within the shell 214. In one example, the aperture 218 can be defined such that the aperture 218 is disposed in front of the user's ear when the user dons the device 200. The wearable electronic device 200 can further include a distal portion 212 coupled to the distal end 216 of the proximal portion 210. The distal portion 212 can define an internal volume 220. The distal portion 212 can further include a flexible portion 228. In one example, the flexible portion 228 can enable the distal portion 212 to have an adjustable curvature, such that the distal portion 212 curvature can be adjusted as to accommodate to a user's unique head or ear size for the comfortability of the user as the user dons the device 200.

In one example, the device 200 can include a speaker 226 disposed in the internal volume 220 of the distal portion 212. The device 200 can further include an audio conduit 222 that can be defined by the flexible portion 228. In one example, the aperture 218 can be disposed proximally to the audio conduit 222. In one example, the flexible portion 228 can include an overmolded portion positioned at least partially over the audio conduit 222. The audio conduit 222 can be defined by the flexible portion 228 between the speaker 226 and the aperture 218. In one example, the audio conduit 222 can define a second internal volume 224. In this way, the audio conduit 222 can be configured to direct audio from the speaker 226 to the aperture 218 through the second internal volume 224. The device 200 including the audio conduit 222 defined by the flexible portion 228 can be advantageous as the manufacturing process can be simplified and require less components disposed in the securement arm 204. In one example, the device 200 can further include a flexible conduit, such as the flexible conduit 122 of FIG. 1. The flexible conduit can be disposed in the second internal volume 224 defined by the audio conduit 222. In this way, the flexible conduit can be used to further strengthen the audio conduit 222 to resist any geometric changes in the second internal volume 224 during adjustment of the curvature.

Any of the features, components, and/or parts, of the rim 360 including the arrangements and configurations thereof shown in FIG. 2 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 2.

FIG. 3A illustrates a side view of a securement arm 304 for a wearable electronic device 300. The securement arm 304 for a wearable electronic device 300 can include a proximal housing 310 and a distal housing 312 defining a curve configured to accommodate an ear of a user. The securement arm 304 can further include a flexible conduit 322 disposed within the distal housing 312. The flexible conduit 322 can define an internal volume 324. The securement arm 304 can include an overmolded flexible material 328 positioned at least partially over the flexible conduit 322. As illustrated in FIG. 3A, the flexible material 328 can cover a majority of an inner surface 334 of the distal housing 312. In another example, the flexible material 328 can cover the entirety of the inner surface 334 of the distal housing 312. In one example, the flexible material 328 can be configured to define the curve of the distal housing 312. In this way, the flexible material 328 can be configured to adjustably change the curve of the distal housing 312 to accommodate to the size and shape of a user's head and ears.

In one example, the securement arm 304 can include a speaker 326 disposed within the distal housing 312, a port 318 disposed proximally to the flexible material 328, and an acoustic seal disposed proximally to the port 318 and disposed in the proximal housing 310. In one example, the flexible conduit 322 can be disposed between the speaker 326 and the port 318. In such an example, the speaker 326 outputs audio and the internal volume 324 of the flexible conduit 322 is configured to direct audio from the speaker 326 to the port 318. In another example, as the audio is directed by the flexible conduit 322 to the port 318, the acoustic seal 336 can stop the audio from going through the entirety of the securement arm 304 and/or redirect the audio from the acoustic seal 336 to the port 318 to ensure the audio is delivered to the port 318. In at least one example, the acoustic seal 336 can also be an environmental seal to prevent dust, debris, moisture, and so forth, from an external environment from entering the proximal portion of the arm 300 through the port 318.

In at least one example, the securement arm 304 can further include a battery 332 disposed within the proximal housing 310. In this example, the speaker 326 disposed in the distal housing 312 and therefore a larger battery 332 can be disposed within the proximal housing 310 and extend the operational time of the device. In one example, the securement arm 304 can further include a microphone 338 and the microphone 338 is disposed within the distal housing 312. In one example, the microphone 338 can be disposed in front of the user's ear and proximal to the port 318. In this position the microphone 338 can receive the audio input from the user such as the user's voice. In this way, the user's voice can be used to execute applications on the device utilizing the microphone 338. In yet another example, the microphone 338 can enable the user to use the user's voice to answer a phone call, participate in a phone call as the speaker 326 can output audio from the device 300 during the phone call.

In one example, the microphone 338 can be part of a feedback loop for controlling the speaker 326. As the speaker 326 outputs audio and the flexible conduit 322 directs the audio to the port 318, the microphone 338 can be configured to pick up the performance of the audio directed to the port 318 as the microphone 338 is disposed proximally to the port 318 and distally to the acoustic seal 336. In this way, as the distal housing 312 curve is adjusted to accommodate to the user's ear and the geometry of the internal volume 324 of the flexible conduit 322 can change in relation to the curvature. As the geometry of the internal volume 324 changes, the properties of the audio waves directed through the internal volume 324 can be affected. In this example, the microphone 338 can be the feedback look to receive the new audio from the speaker 326, and the microphone 338 and the speaker 326 can be in electrical communication with each other and with a controller of the device such that the speaker 326 can adjust the audio output based on the audio received by the microphone 338 to optimize the quality of the audio with respect to the new geometry of the flexible conduit 322.

FIG. 3B illustrates a cross-sectional view viewed at the bisecting line 301 in FIG. 3A of one example of a securement arm 304 for a wearable electronic device. As illustrated in FIG. 3B, the securement arm 304 can define a width 340 or a port cross-section width such that the width 340 can be defined such that the securement arm 304 can be supported by the user's ear and comfortably rest between the user's head and ear. In this way, the securement arm 304 does not bend the top of the user's ear outward. In at least one example, the device and the securement arm 304 can include a tape 342. As illustrated in FIG. 3B, the tape 342 can cover an outer surface of the flexible conduit 322. In this way, the tape 342 can seal the internal volume 324 of the flexible conduit 322.

Any of the features, components, and/or parts, of the rim 360 including the arrangements and configurations thereof shown in FIG. 3A-3B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3A-3B.

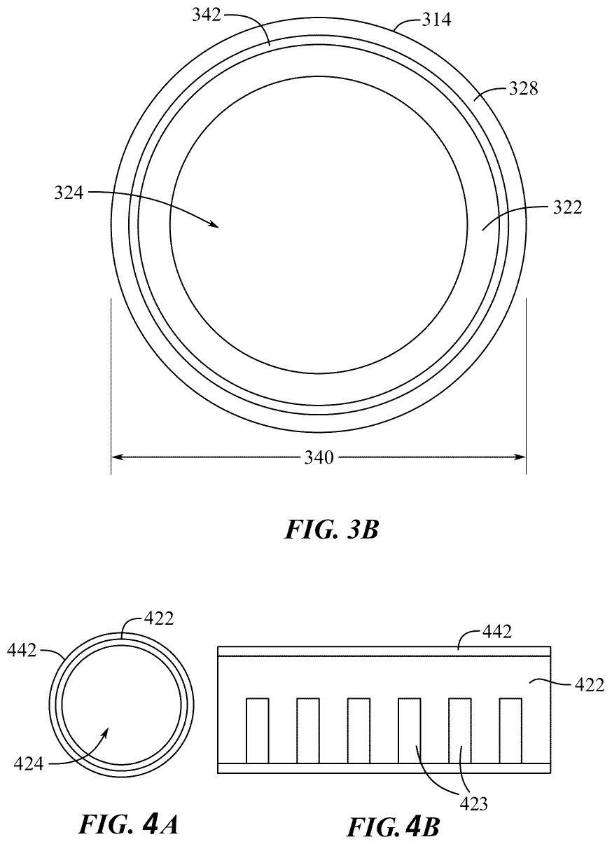

FIG. 4A illustrates a cross-sectional view of one example of a flexible conduit 422 taken along a plane parallel to the plane 301 indicated in FIG. 3A and FIG. 4B illustrates a cross-sectional view of the flexible conduit 422 taken along a plane perpendicular to the plane 301 indicated in FIG. 3A. In one example, the flexible conduit 422 can be a slotted tube and the tape 442 can cover the outer surface of the flexible conduit 422. In at least one example, the slotted tube can include one or more slots 423 extending at least partially across a width of the flexible tube 422.

In this way, the slotted tube can distribute the bending moment to stop a kink from occurring in the internal volume 324 as the user adjusts the curvature of the distal housing 312. As the flexible conduit 422 is disposed in the distal housing 312 of the securement arm 304 the flexible material 328 can be an overmolded portion positioned at least partially over the flexible conduit 422 and the tape 442. In this example, the tape 442 maintains the integrity and cross-sectional shape of the internal volume 424 as the flexible material 328 is overmolded over the flexible conduit 422 and the tape 442 during the manufacturing process.

Any of the features, components, and/or parts, of the rim 360 including the arrangements and configurations thereof shown in FIG. 4A-4B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 4A-4B.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A wearable electronic device, comprising:
a frame;
a display window coupled to the frame;
a securement arm comprising:
a proximal portion comprising a shell pivotally coupled to the display frame at a proximal end of the shell, the shell having a distal end opposite the proximal end and defining a port between the distal end and the proximal end; and
a distal portion coupled to the distal end, the distal portion defining a first internal volume having an adjustable curvature;
a flexible conduit disposed in the first internal volume, the flexible conduit defining a second internal volume; and
a speaker disposed in the first internal volume, the second internal volume configured to direct sound from the speaker to the port.

2. The wearable electronic device of claim 1, further including a battery disposed within the shell.

3. The wearable electronic device of claim 1, wherein the flexible conduit comprising a slotted tube.

4. The wearable electronic device of claim 1, the distal portion further comprising a flexible section.

5. The wearable electronic device of claim 1, wherein the flexible conduit is disposed between the speaker and the port.

6. The wearable electronic device of claim 5, further including a tape covering an outer surface of the flexible conduit to seal the second internal volume.

7. The wearable electronic device of claim 6, wherein the flexible portion comprises an overmolded material positioned at least partially over the flexible conduit and the tape.

8. The wearable electronic device of claim 1, further comprising a microphone disposed within the proximal portion.

9. The wearable electronic device of claim 1, further comprising:
a transparent window coupled to the display frame; and
a projector configured to direct light displayed at the transparent window.

10. The wearable electronic device of claim 1, further comprising an acoustic seal disposed in the proximal portion, the acoustic seal disposed proximal to the port.

11. A wearable electronic device, comprising:
a display frame;
a display window coupled to the display frame;
a securement arm comprising:
a proximal portion comprising a shell pivotally coupled to the display frame at a proximal end of the shell, the shell having a distal end opposite the proximal end and defining an aperture; and
a distal portion coupled to the distal end, the distal portion defining an internal volume and the distal portion including a flexible portion;
a speaker disposed in the internal volume; and
an audio conduit defined by the flexible portion between the speaker and the aperture.

12. The wearable electronic device of claim 11, wherein the aperture is disposed proximally to the audio conduit.

13. The wearable electronic device of claim 11, wherein the audio conduit is configured to direct audio from the speaker to the aperture.

14. The wearable electronic device of claim 11, further comprising a battery disposed within the shell.

15. The wearable electronic device of claim 11, wherein the audio conduit defines a second internal volume.

16. The wearable electronic device of claim 11, wherein the flexible portion comprising an overmolded portion positioned at least partially over the audio conduit.

17. A securement arm for a wearable electronic device, comprising:
a proximal portion configured to be disposed in front of an ear of a user when donned;
a distal portion configured to be disposed behind the ear when donned; and
a speaker disposed within the distal portion.

18. The securement arm for a wearable electronic device of claim 17, further comprising:
a flexible conduit disposed within the distal portion, the flexible conduit defining an internal volume;
an overmolded flexible material positioned at least partially over the flexible conduit;
a port disposed proximally to the flexible material; and
an acoustic seal disposed proximally to the port.

19. The securement arm for a wearable electronic device of claim 18, wherein the flexible conduit is disposed between the speaker and the port.

20. The securement arm for a wearable electronic device of claim 18, wherein the flexible conduit is configured to direct audio from the speaker to the port.
